(19) United States
(12) Patent Application Publication
(10) Pub. No.: US 2016/0364277 A1
(43) Pub. Date: Dec. 15, 2016

(54) A METHOD FOR USING USER SESSION DATA TO PROVIDE MIDDLE-WARE

(71) Applicant: EVADO HOLDINGS PTY LTD, Melbourne (AU)

(72) Inventor: Ross ANDERSON, MELBOURNE (AU)

(21) Appl. No.: 15/118,097

(22) PCT Filed: Feb. 11, 2015
(86) PCT No.: PCT/AU2015/000076

§ 371 Date: Aug. 11, 2016

(30) Foreign Application Priority Data
Feb. 11, 2014 (AU) 2014900409

(51) Int. Cl. G06F 9/54; G06F 17/30; G06Q 10/06

(52) U.S. Cl. CPC G06F 9/541; G06Q 10/067; G06F 17/30864

(57) ABSTRACT

There is disclosed a web application or mobile app service containing a session based middle layer between the web application or mobile app service and the business application to facilitate the integration of the user generated transactions with the one or more business applications where: a the session middleware layer isolates the web application or mobile app service from the underlying business applications where : b each user generated transaction triggers at least one primary transaction event in a business application; c user generated transaction can trigger one or more secondary transaction events in one or more business applications to complete the processing of the user transaction request; d the session middleware layer functionality manages the business logic to determine the order of business applications methods are executed to complete the user generated transaction requests.

This invention provides a method of using user session data to provide a middle-ware function to integrate data across multiple applications thereby providing a method of sharing user generated data between applications by enabling the data stored in the user session to be shared across one or more applications.

### BACKGROUND

Middle-ware systems and software have been used extensively to connect different applications together, to automate business processes across multiple applications to complete business workflows.

The typical middleware software systems are sited between two or more applications passing transactions between the systems. In some implementations the middleware acts as a broker between the applications and perform data transformation as transaction objects are passed between the applications in order to mediate the transactions between the applications.

### PRIOR ART

U.S. Pat. No. 7,003,482 B1-Middleware for business transactions

U.S. Pat. No. 7,216,181 B1-Middleware brokering system

U.S. Pat. No. 8,032,636 B2-Dynamically provisioning clusters of middleware appliances

US 20130227547 A1-Adaptable middleware layer

### Prior Art Discussion

Many companies, such as insurance companies and financial service organizations, have come to rely on software systems to help operate their businesses. The software systems may include a program or programs that process and store data associated with business transactions. Such programs may be referred to as business transaction servers. To process a particular business transaction, one or more business transaction servers may be used.

To use a business transaction server, an interface program may be needed to interact between the business transaction server and a user. Typically, the interface program receives input data from the user, transforms the data into a form that is recognizable to the business transaction server, and transmits the data to the server. The server receives the data, processes the data, and the server returns results to the interface program. The interface program receives the results from the server and the interface program may transform the results into a desired output form. The interface program may provide both a graphical user interface to a specific data input source, and a functional interface that communicates with a business transaction server.

There are many different systems and ways in which a user may input data.

A system for inputting data into a computer system may be referred to as a “channel.” Channels include, but are not limited to, office terminal entry systems, kiosk systems, Internet systems, and telephone centre assistance systems. A channel may be limited to certain types of transactions. For example, in the insurance industry, a kiosk entry system may be set up to process only insurance quotes, while an office terminal entry system located in an insurance company office may be set up to allow all available types of insurance transactions.

The order in which data is requested from a user for a specific type of transaction may vary depending upon which type of channel is being used. For example, when a telephone assistance centre entry system is used, one of the first pieces of information requested from the user is the user's name; while the user's name is often one of the last pieces information requested from a user when using an Internet entry system. Because the order in which data is entered for different types of channels may vary, the interface program between a user and a business transaction server may be different for each different channel.

Typically, a company wants the graphical user interface that the company uses to be unique. Even if two companies use the same types of business transaction servers for the same types of business transactions, it is very likely that the graphic user interfaces for the two companies will be different. An interface program supplier may not be able to write one generic set of computer code that operates as an interface program for several different clients.

Typically, programmers write computer code to create a required interface program between a specific type of channel and a business transaction server or servers. If a company wants to offer the ability to enter data through a different type of channel that requires a different mode or layout for data entry, another interface program would have to be written for the new channel. Typically, programmers who create interface programs have to code both a graphical user interface and a functional interface to the business transaction server or servers.

Writing computer code to provide the required interfaces typically requires specialist programmers who are familiar with the data requirements of the server, and who are also familiar with the specific requirements of data entry for the channel. Writing computer code to provide interfaces for two different types of channels may result in inefficient duplication of code in separate programs.

Developing an interface system between a user and a business transaction server could take months. One approach towards reducing development time is to use object-oriented software design techniques. Object-oriented software design may include the use of objects and classes. An object may include an encapsulation of data and methods for manipulating the data. A class may include a template for an object. An object is therefore an instance of a class, and an object is created by instantiating it from a class. Object-oriented techniques, when used properly, may permit the re-use of previously written program code such as classes.

Web browser interaction with a web server over an IP connection using HTTP protocol is well known in the art.

There many web applications incorporate multiple services into the web application such as an online shop using a payment gateway to complete a purchase. In general these application have a single purpose, and the external services are directly associated with execution of the primary purpose.

With the advent of mobile computing it has been necessary to substantially simplify many business applications when delivering them over a mobile device. As a result it has been necessary to split business systems over one more applications running on mobile devices with the result that many users are forced to open multiple applications in order to complete a work task.

It is an object of at least embodiments of the present invention to address or ameliorate the above-mentioned problems.

### Definitions and Terminology

Application is a business application that the middleware software is communicating with.

Middleware software sits between different applications passing business transactions between the different applications.

Session data this is data that has been user generated as the user transactions with the applications integrated into the User Application.

User Application is an application that a user interacts with. This application could be a native application running on the user workstation or a web application where the user is interacting with the application via web browser or mobile application.

User Interface is the user interface to the User Application.

Primary event is a transaction event that is initiated by the user. This could be a query, retrieval, and business process step or data update event.

Secondary event is a transaction event that is initiated by a primary event as part of its execution process.

### BRIEF DESCRIPTION OF INVENTION

This invention seeks to extend the typical web application functionality to enable the application to execute multiple workflow processes that are initiated by the user. These workflow processes may be ad hoc enabling the user to dynamically move between the different applications or as a pre-defined process that the user is working through.

In preferred embodiments, this is achieved by sharing user's session data across multiple different applications. In preferred embodiments, this is achieved by terminating the different applications into an integrating software component that allows the user to access and execute each application's components and store access data structures in a common data area.

As a result, as the user executes their business process they retrieve and store application data that follows their workflow process.

The stored data once accessed and stored in the user session, the data object can be used or be passed to other applications as the user seeks to access different applications.

For Example Repairing a Fridge:
(a) the service person accesses the customer details, once opened this data is held in the user session;
(b) on booking out the spare part the part's details are also held in the user's session;
(c) when creating the order the customer and spare parts details stored in the user's session can be used to pre-fill the order form.

This process reduces the need to re-enter data or query the application databases to fill the order form.

Accordingly, in one broad form of the invention, there is provided a method of inserting a middle ware layer between a web application's user interface or web application service and business applications; said method comprising the steps:
(a) Placing the middle ware layer within and as part of the user session environment;
(b) Effecting direct data access between the middle ware layer and the user session storage; and
(c) Effecting a standardised interface between the user interface or service and the business applications
(d) Thereby to facilitate integration between multiple ones of the business applications.

Preferably, the Method Further Includes the Steps:
(a) the session based middleware layer isolates the web application or mobile app service from the underlying business applications where:
(b) each user generated transaction triggers at least one primary transaction event in a business application;
(c) each user generated transaction can trigger one or more secondary transaction events in one or more business applications to complete the processing of the user transaction request;
(d) the session middleware layer functionality manages the business logic to determine the order in which business applications methods are executed to complete the user generated transaction requests.

Preferably each Transaction Event Process Consists of:
(a) transforming of session middleware layer data objects into business application data objects;
(b) calling the relevant business application method or function;
(c) transforming the data object returned by the business application method or function into a session middleware data object; and
(d) returning the middleware object to session middleware layer.

Preferably the Session Middleware Layer is Able to:
(a) transform any of the referenced business application data objects into a middleware layer equivalent and;
(b) transfer any middleware layer data object into a referenced business application data object.

Preferably the session middleware layer contains the logic necessary to define the primary business application event and all secondary business application events needed to complete any arbitrary user transaction, thereby defining the process for completing any user generated request.

Preferably the session middleware logic contains the necessary business rules to determine when any primary or secondary business event is to be triggered, this logic includes:
(a) the source transaction event;
(b) system states to trigger the primary event;
(c) business application method to be called to complete the primary event;
(d) a list of secondary events where each secondary event is defined including:
   (i) event sequence
   (ii) the system status to trigger the secondary event,
   (iii) business application method to be called to complete the secondary event ; and
   (iv) the role back execution path for each transaction failure mode.

Preferably the interfaces between the middleware layer and the business applications are reusable across multiple different middleware transaction events, or when new business applications are added to the middleware layer environment.

Preferably the cross references between middleware layer and business applications object can be implemented directly in middleware layer application source code or stored in a data file or database and loaded on application start up.

Preferably the middleware event logic can be implemented directly in middleware layer application source code or stored in a data file or database and loaded on application start up.

In a further broad form of the invention, there is provided a system consisting of a middle ware layer inserted between a web application's user interface or web application service that:
(a) is part of the user session environment;
(b) has direct access to the user session storage; and
(c) provides a standardised interface between the user interface or service and underlying business applications to facilitate the integration between the multiple business applications.

Preferably a web application or mobile app service contains a session based middleware layer between the web application or mobile app service and the business applications, whereby the system facilitates the integration of user generated transactions generated via the web application with the one or more business applications; the system further including:
(a) means by which the session based middleware layer isolates the web application or mobile app service from the underlying business applications where:
(b) each user generated transaction triggers at least one primary transaction event in a business application;
(c) each user generated transaction can trigger one or more secondary transaction events in one or more business applications to complete the processing of the user transaction request;
(d) the session middleware layer functionality manages the business logic to determine the order of business applications methods are executed to complete the user generated transaction requests.

Preferably each Transaction Event Process Consists of:
(a) transforming of session middleware layer data objects into business application data objects
(b) calling the relevant business application method or function;
(c) transforming the data object returned by the business application method or function into a session middleware data object;
(d) returning the middleware object to the session middleware layer.

Preferably the Session Middleware Layer is Able to:
(a) transform any of the referenced business application data objects into a middleware layer equivalent and;
(b) transfer any middleware layer data object into a referenced business application data object.

Preferably the session middleware layer contains the logic necessary to define the primary business application event and all secondary business application events needed to complete any arbitrary user transaction, thereby defining the process for completing any user generated request.

Preferably the session middleware logic contains the necessary business rules to determine when any primary or secondary business event is to be triggered, this logic including:
(a) the source transaction event;
(b) system states to trigger the primary event;
(c) business application method to be called to complete the primary event;
(d) a list of secondary events where each secondary event is defined including:
   (i) event sequence
   (ii) the system status to trigger the secondary event,
   (iii) business application method to be called to complete the secondary event ; and
   (iv) the roll back execution path for each transaction failure mode.

Preferably the interface between the middleware layer and the business applications is reusable across multiple different middleware transaction events, or when new business applications are added to the middleware layer environment.

Preferably the cross references between middleware layer and business application objects can be implemented directly in middleware layer application source code or stored in a data file or database and loaded on application start up.

Preferably the middleware event logic can be implemented directly in middleware layer application source code or stored in a data file or database and loaded on application start up.

In a further broad form of the invention there is provided a web application or mobile app service containing a session based middle layer between the web application or mobile app service and the business to facilitate the integration of the user generated transactions with the one or more business applications where:
(a) the session middleware layer isolates the web application or mobile app service from the underlying business applications where:
(b) each user generated transaction triggers at least one primary transaction event in a business application;
(c) user generated transaction can trigger one or more secondary transaction events in one or more business applications to complete the processing of the user transaction request;
(d) the session middleware layer functionality manages the business logic to determine the order of business applications methods are executed to complete the user generated transaction requests.

Preferably each Transaction Event Process Consists of:
(a) transforming of session middleware layer data objects into business application data objects
(b) calling the relevant business application method or function;
(c) transforming the data object returned by the business application method or function into a session middleware data object;
(d) returning the middleware object to session middleware layer.

Preferably the Session Middleware Layer is Able to:
(a) transform any of the referenced business application data objects into a middleware layer equivalent and;
(b) transfer any middleware layer data object into a referenced business application data object.

Preferably the session middleware layer contains the logic necessary to define the primary business application event and all secondary business application events needed to complete any arbitrary user transaction, thereby defining the process for completing any user generated request.

Preferably the session middleware logic contains the necessary business rules to determine when any primary or secondary business event is to be triggered, this logic includes:
(a) the source transaction event;
(b) system states to trigger the primary event;
(c) business application method to be called to complete the primary event;
(d) a list of secondary events where each secondary event is defined including:
   (i) event sequence
   (ii) the system status to trigger the secondary event,
   (iii) business application method to be called to complete the secondary event ; and
   (iv) the role back execution path for each transaction failure mode.

Preferably the interfaces between the middleware layer and the business applications are reusable across multiple different middleware transaction events, or when new business applications are added to the middleware layer environment.

Preferably the cross references between middleware layer and business application's object can be implemented directly in middleware layer application source code or stored in a data file or database and loaded on application start up.

Preferably the middleware event logic can be implemented directly in middleware layer application source code or stored in a data file or database and loaded on application start up.

### BRIEF DESCRIPTION OF DRAWINGS

Embodiments of the present invention will now be described with reference to the accompanying drawings wherein:

FIG. 1 illustrates a typical prior art middleware structure

FIG. 2 illustrates a prior art session middle structure

FIG. 3 outlines an extension to FIG. 2 by incorporating multiple business applications within the one web environment, often referred to as a portal

FIG. 4 outlines an extension to FIG. 3

FIG. 5 illustrates a framework for inserting a middleware layer between a web application and the backend applications in accordance with an embodiment of the invention

FIG. 6 outlines a preferred hospital system embodiment containing the middleware layer of FIG. 5

### DETAILED DESCRIPTION OF EMBODIMENTS

### Prior Art Middleware Embodiment

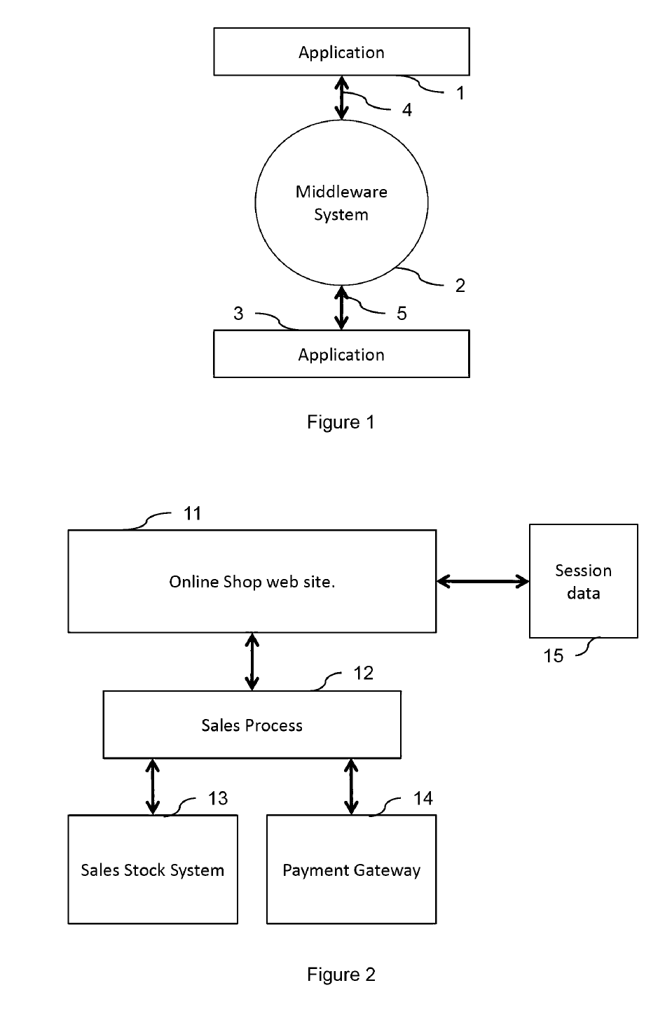

In summary with reference to FIG. 1, describes a typical prior art implementation of a middleware implementation consisting of:
(a) Application 1, 3 are independent applications involved in different business processes.
(b) Middleware 2 connects application 1 and application 2 via connection 4 and 5.

At an appropriate step in Application 1, workflow process a transaction needs to be sent to application 3. This transaction could be a request to update a stock level. The sending application 1 sends a transaction in its native format to the middleware system 2 via connection 4.

On receiving the transaction middleware system 2, identifies the end recipient of the transaction, then transforms the transaction structure in to a compatible format for the application receiving the transaction. The middleware system 2 then forwards the transaction the receiving application 3 via connection 5.

Application 3 on receiving the transaction, executes the transaction locally and the sends the appropriate response as a transaction to middleware 3 via connection 5.

Middleware 2 on receiving the transaction, identifies it recipient, transforms the transaction into it native format and forwards it to the receiving application 1 via connection 4.

### Prior Art Online Shop Embodiment

FIG. 2 outlines the typical prior art web application structure for a online shop of:
(a) A Online shop web site 11 resides on a web server and managing the web user interface. The generated pages are sent to the users web browser over and IP network e.g. Internet;
(b) A Sales Process 12 manages the execution of the product sales process.
(c) The Sales stock system 13 contains the shops stock management data.
(d) The Payment Gateway 14 to process credit card or direct debit transactions.
(e) Session data 15 stores persistent data that the user has retrieved from the application and is connected to the web service by connection 15.

As the HTTP protocols are stateless, the web server maintains creates user sessions to manage the user's transactions has with the Web Application 11 over a period of time. The user session persist for a specific period of time after the last transaction received by the web server. After this period of time the session will be disposed of along with any data associated with it. Data associated with a specific session is stored in the Session data object 15.

Where Web Application 11 needs to persist data across multiple user transactions, Business Application 12 data object are saved as session data 13. Session data 15 persists for the duration of the use session with the web server.

On the user submitting a HTTP transaction to the Web Application 11 the user's session data 15 is retrieved and used to initialise data objects with session content generated in the previous user transactions.

The received transaction is processed and if a sales process passed to the Sales Process 12 components. The sales process components 12 interact with the Sales Stock System 13 to display stock, record customer orders. The sales process components interact with the payment gateway 14 to process customer payments.

The retrieved session data can be updated during any time during the processing of the user's transaction and saved to session data 15. This provides a method of maintaining continuous storage throughout out the sales process 12 across multiple user transactions with the online shop web site 11, for the duration of the user's session.

The method of storing and retrieving session data 15 is dependent upon the software development framework. In .NET the program can store and retrieve any .NET object into the Session objects.

In some instances the Web Application 11 and Sales Process 12 may reside as a single software application.

### Prior Art Hospital System Embodiment

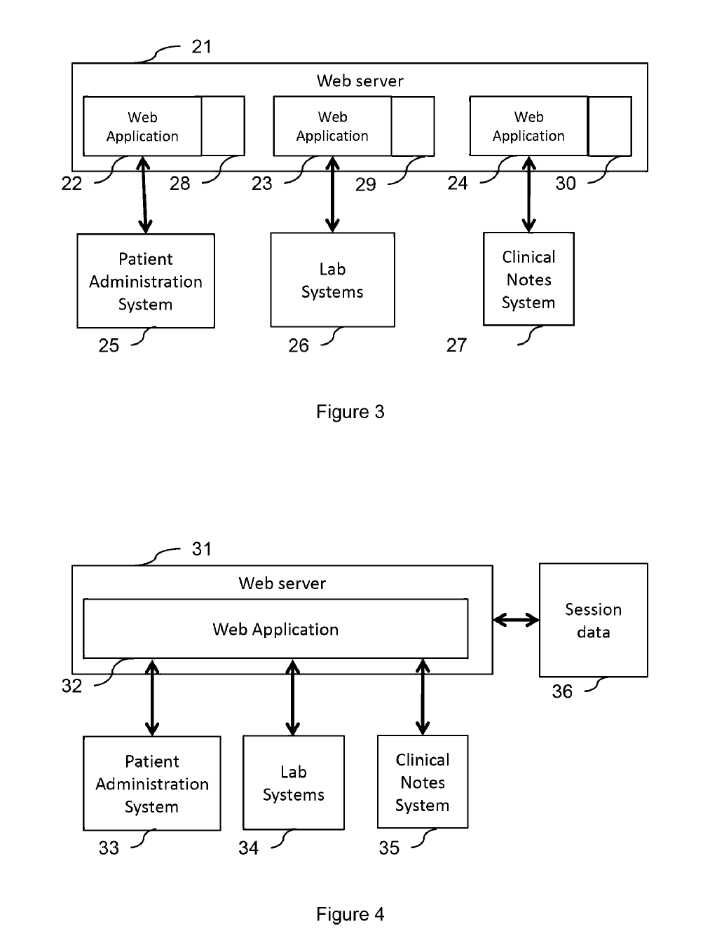

FIG. 3 outlines an extension to FIG. 2 by incorporating multiple business applications within the one web environment, often referred to as a portal.

FIG. 3 Includes:
(a) Web server 21 contains three web applications 22, 23, 24, each web application contains it own session data, 28, 28 and 30 respectively;
(b) Web application 22 provides a user interface to the patient administration system 25;
(c) Web application 23 provides a user interface to the lab system 26;
(d) Web application 24 provides a user interface to the clinical notes system; and
(e) Users are able to move between the web applications via HTTP links.

The user interacts with the patient administration system 25 by submitting HTTP transaction to web application 22.

When web application 22 receives a user transaction the user session data 28 is retrieve into the web application memory to provide data continuity between user transactions for the duration of the user session with the web application.

After retrieving the user session data 28 into memory web application 22 processes the user transaction request, by interacting with the patient administration system 25. To generate an appropriate html response document.

At the completion of the processing of the user's transaction relevant application data is saved to session data 28 to make it available for the next user transaction.
(a) The user interacts with the lab system 26 by submitting HTTP transaction to web application 23:
(b) When web application 23 receives a user transaction the user session data 29 is retrieve into the web application memory to provide data continuity between user transactions for the duration of the user session with the web application.
(c) After retrieving the user session data 29 into memory web application 23 processes the user transaction request, by interacting with the lab system 26. To generate an appropriate html response document.
(d) At the completion of the processing of the user's transaction relevant web application data is saved to session data 29 to make it available for the next user transaction.

The user interacts with the clinical notes system 27 by submitting HTTP transaction to web application 24:
(a) When web application 24 receives a user transaction the user session data 30 is retrieve into the web application memory to provide data continuity between user transactions for the duration of the user session with the web application.
(b) After retrieving the user session data 30 into memory web application 24 processes the user transaction request, by interacting with the lab system 27. To generate an appropriate html response document.
(c) At the completion of the processing of the user's transaction relevant web application data is saved to session data 30 to make it available for the next user transaction.

Depending upon the web application 22, 23, 24, implementation it is possible to pass information between the web applications using HTTP link. However the information is limited to the information that can be embedded into a HTTP link.

A limitation of this embodiment is that while the user may only login once, the user will have separate use sessions with each web application 22, 23, 24, each having it own session data storage 28, 29, 30.

### Prior Art Hospital System Embodiment Extended

FIG. 4 outlines an extension to FIG. 3 by combining each of the separate web applications 22, 23, 24 in FIG. 3 into a single web application 32.

FIG. 4 Includes:
(a) Web server 31 contains one web application 32, with its own session data 36;
(b) Web application 32 provides a user interface to the patient administration system 33;
(c) Web application 32 provides a user interface to the lab system 34;
(d) Web application 32 provides a user interface to the clinical notes system 35; and
(e) Users are able to move between the web application 31 pages via HTTP links.

The user interacts with the patient administration system 33 by submitting HTTP transaction to web application 32.
(a) When web application 32 receives a user transaction the user session data 36 is retrieve into the web application memory to provide data continuity between user transactions for the duration of the user session with the web application.
(b) After retrieving the user session data 36 into memory web application 32 processes the user transaction request, by interacting with the patient administration system 33. To generate an appropriate html response document.
(c) At the completion of the processing of the user's transaction relevant application data is saved to session data 36 to make it available for the next user transaction.

The user interacts with the lab system 34 by submitting HTTP transaction to web application 32:
(a) When web application 32 receives a user transaction the user session data 36 is retrieve into the web application memory to provide data continuity between user transactions for the duration of the user session with the web application.
(b) After retrieving the user session data 36 into memory web application 32 processes the user transaction request, by interacting with the lab system 34. To generate an appropriate html response document.
(c) At the completion of the processing of the user's transaction relevant web application data is saved to session data 36 to make it available for the next user transaction.

The user interacts with the clinical notes system 35 by submitting HTTP transaction to web application 32:
(a) When web application 32 receives a user transaction the user session data 36 is retrieve into the web application memory to provide data continuity between user transactions for the duration of the user session with the web application.
(b) After retrieving the user session data 36 into memory web application 32 processes the user transaction request, by interacting with the lab system 35. To generate an appropriate html response document.
(c) At the completion of the processing of the user's transaction relevant web application data is saved to session data 36 to make it available for the next user transaction.

While each of the application modules or systems 33, 34, 35 can operation independently. The integrated environment provides the ability to share session data across each of the modules. This can streamline the modules operation by re-using user retrieved data. For example: Having retrieved patient information from the patient administration system 33, this data can be used to initialize lab system 34 or clinical notes system 35 queries.

### User Session Middleware Layer Embodiment

As described below, embodiments of the present invention provides a framework for inserting a middleware layer between a web application and the backend applications, to manage the integration between the web application and the backend applications. This arrangement also provides a native interface to each of the backend applications while controlling the interactions across multiple backend applications to complete the web application user's transaction requests.

The embodiments of the invention extends the web application architecture outlined in FIG. 4 to include a logical middleware layer between the web application 41 and the backend applications or modules 44 & 45 called the session middleware layer 43.

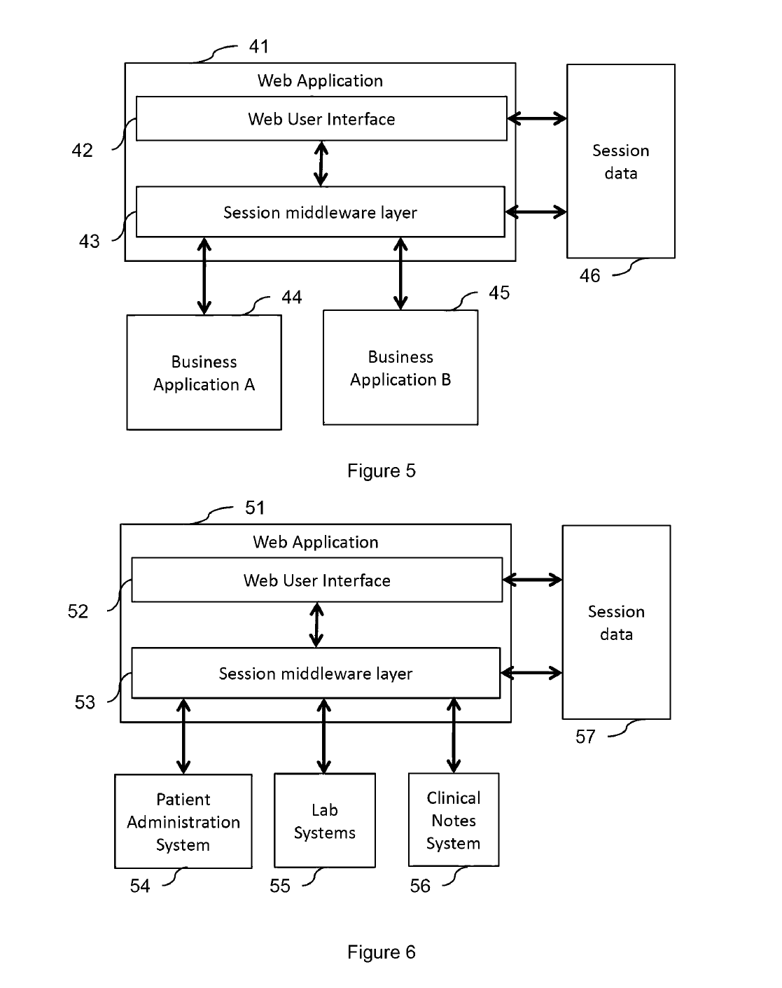

FIG. 5 Outlines this Extension:
(a) Web applications 41, contains a web user interface 42 with associated session data 46.
(b) The web user interface 42 is connected to the session middleware layer 43 and all communications to the business applications A & B 44, 45 is sent via the session middleware layer 43.
(c) The session middleware layer 43 communicates with the business applications A & B 44, 45 using each business applications native APIs (Application Programming Interface).
(d) The session middleware layer 43, have access to session data 46, to store and retrieve user session data across multiple user web transaction.

The session middleware layer 43 provides a number of services to both the web user interface 42 and the business applications 44, 45:
(a) The web application 41 is able to a standardised API to communicate with the business applications 44, 45 regardless of the number of backend applications in the system;
(b) The session middleware layer 43 handles all interactions with the business applications 44 & 45 using their native application interfaces;
(c) The session middleware layer 43 stores middleware data objects in the user session data 46;
(d) Web user interface 42 events e.g. updating data, can trigger multiple backend application 44, 45 events by:
   (i) triggering events in the targeted business application 44 or 45; then
   (ii) triggering secondary events in other backend applications 44 or 45.
(e) The interface descriptions and event business rules for each backend application can be implemented as:
   (i) hardcode into the session middleware layer 43 source code; or
   (ii) defined as configuration files that are read by the session middle ware layer 43 when the web application 42 starts.

The Middleware Layer 43 Consists of:
(a) data transformation functions to convert business application data into a common format that can be passed to the web application or to another business application;
(b) business event logic function to define the event hierarchy for each user initiated event (transaction). These could include:
   (i) web user interface 42 event triggering primary events in business application A 44 or business application B 45;
   (ii) business application A 44 event triggering secondary events in business application B 45;
   (iii) business application B 45 event triggering secondary events in business application A 44;
   (iv) other inter-business application events.

The event execution framework needs to sense when an event has been triggered, e.g. retrieve an object. To identify the events to be generated and data transformation that is required to pass the relevant data to the backend application 44, 45 for processing.

The data transformation functions, consists of a bi-directional cross-reference between the backend applications 44 and 45 data objects and the session middleware 43 data structures. This enables a data object received from business application a 44 to be converted into session middleware layer 43 data object, which then passed to web user interface 42 to be displayed on a html page or transformed and passed to business application B 45 for further processing.

For Example a Data Object Mapping may be Implemented as:
(a) App_A.Customer.FName==SMW.Customer.FirstName
(b) App_B.Customer.FirstName==SMW.Customer.FirstName
(c) App_A.Customer.LName==SMW.Customer.FamilyName
(d) App_B.Customer.FamilyName==SMW.Customer.FamilyName

The Data Transformation Function Consists of:
(a) passing in middleware layer data 43 object and returning the relevant business application 44 or 45 data object; or
(b) passing in business application 44 or 45 data object and returning relevant middleware layer 43 data object.

The business event logic function needs to have a logic structure that defines:
(a) each user transaction
(b) the primary event it executes
(c) primary event parameters;
(d) the secondary events;
(e) secondary event parameters;
(f) business logic governing when the secondary events are to be triggered.

### An Example Multi-event Process

When the web application 42 receives a HTTP transaction from a user requesting a specific web page. The user interface layer session data 46 is retrieved a loaded into the web user interface 42 memory, the web user interface 42 processes the URL request:
(a) Creating a session middleware layer 43 event by converting the URL parameters into the appropriate middleware 43 data object and passing the object to the session middleware layer 43 event function or method;
(b) The session middleware layer 43 receives the data object from the web user interface 42, converts the data object into the appropriate business application A business application A 44 data object and executes the primary event by passing the business application A business application A 44 data object to the appropriate function or method for processing.
(c) Business Application A 44 executes the method call and returns the appropriate data object, which is passed back to the session middleware layer 43.
(d) The session middleware layer 43 receives the business applications A 44 function or method's returned data object and converts the data object into the appropriate middleware layer 43 data object and stores the data in the user's session object, then:
   (i) executes each secondary event by passing the business application B 45 data object to the appropriate function or method for processing;
   (ii) receives the business applications function or method's returned data object and converts the data object into the appropriate middleware layer 43 data and stores the data in the user's session object;
   (iii) if a secondary event fails to take appropriate steps to handle the event in a consistent manner;
   (iv) performs any clean-up processes and merging of middleware data objects; and
   (v) passes the middleware data objects back to the web user interface 42 to be displayed as an HTML page.

The Middleware Layer 43 Provides:
(a) the web user interface 42 with a standardised interface for interacting with multiple backend applications 44 & 45;
(b) a native reusable interface to interact with each backend application;
(c) the transaction logic to ensure that each user generated transaction interacts with the correctly backend application in the correct order; and
(d) provide a layer for managing the roll back transactions should that be necessary.

### Preferred Hospital System Embodiment

FIG. 6 Outlines a Preferred Hospital System Embodiment Containing the Middleware Layer:
(a) Web application 51, contains a web user interface 52 with associated session data 57.
(b) The web user interface 52 is connected to the session middleware layer 53 and all communications to the Patient Administration System 54, Lab Systems 55 and Clinical Notes System 56 is sent via the session middleware layer 53.
(c) The session middleware layer 53 communicates with the Patient Administration System 54, Lab Systems 55 and Clinical Notes System 56 using each business applications native APIs (Application Programming Interface).
(d) The session middleware layer 53 has access to session data 57, to store and retrieve middleware data objects across multiple user web transaction.

The session middleware layer 53 provides a number of services to both the web application 52 and Administration System 54, Lab Systems 55 and Clinical Notes System 56:
(a) The web application 51 is able to a standardised API to communicate with the backend systems: Administration System 54, Lab Systems 55 and Clinical Notes System 56.
(b) The session middleware layer 53 handles all interactions with the Administration System 54, Lab Systems 55 and Clinical Notes System 56 using their native application interfaces.
(c) Web user interface 52 events e.g. updating data, can trigger Administration System 54, Lab Systems 55 and Clinical Notes System 56 events by:
   (i) triggering events in the targeted health application 54, 55 or 56;
   (ii) then triggering secondary events in other health applications 54, 55 or 56.

The user sends a request to search for a specific patient's details via the web user interface 52. This request triggers primary transaction event to the Patient Administration System 54 this is achieved by:
(a) transforming the use request into a middleware data object. This object is transformed into Patient Administration System 54, patient query parameter objects and then passed to the patient query method;
(b) the Patient Administration System 54 responds with a collection of patient detail objects. These objects are transformed to a list of middleware patient data object and passed to the middleware layer 53 and stored as middleware objects in the user session 57; and
(c) the resulting middleware patient data is then formatted and sent to the user's web browser as an html.

The user sends a request to retrieve the patient's laboratory reports. This request is triggers a primary transaction to request patient laboratory reports this is achieved by:
(a) Retrieving the middleware patient object containing the patient's details from session data 57.
(b) The patient details object is transformed into a laboratory system 55 patient query parameter objects and then passed to the query method.
(c) The Laboratory System 55 responds with a collection of lab reports objects. These objects are transformed to a list of middleware lab report data object and passed to the Middleware layer 53 and stored in the user session 57.
(d) The resulting middleware list of lab report data is then formatted as a list of reports and sent to the user's web browser as an html.

The user sends a display request selecting a specific report. This request is converted to transaction event retrieve a specific lab report. As the laboratory reports are in user session memory 57, the selected report can be retrieved and formatted as a lab reports and sent to the user's web browser as an html.

The updates a patient details, this request could affect multiple backend systems. This request triggers a primary event to update the patient's details in the Patient Administration System 54, and secondary events to update the Lab system 55 and the clinical notes system 56. This is achieved by:
(a) Updating the patient's details and sending it to the web user interface 52.
(b) The web user interface 52 passes patient details update request to the middleware layer 53 as a middleware patient details data object.
(c) The middleware layer 53, checks the updatable status of the patient data, and sends an error message if the patient's details are not updatable.
(d) The middleware layer 53 generates a primary event by:
   (i) converting the middleware patient data object into the parameters to update the patient's details in the Patient Administration System 54; then
   (ii) executes the patient update method to update the patient's details.
(e) On successfully updating the patient details the secondary update events are triggered by:
   (i) The middleware layer 53 generating a secondary event to update the lab system by:
      (1) converting the middleware patient data object into parameters to update the patient's details in the lab system 55; then
      (2) executes the patient update method to update the patient's details.
   (ii) The middleware layer 53 generating a secondary event to update the lab system by:
      (1) converting the middleware patient data object into parameters to update the patient's details in the clinical notes system 56; then
      (2) executes the patient update method to update the patient's details.

By inserting the middleware layer 53 into the hospital system embodiment, it is possible to ensure that when a user sends a request that the appropriate systems are accessed and updated correctly with a defined role back pathway should that be necessary.

In addition the interface between middleware layer 43 or 53, the business applications 44, 45 or hospital system 54, 55, 56 can be standardised to provide a reusable interface between the middleware layer 43 or 53 and the business applications to facilitate changes to the middleware transaction process flows or the addition of new transaction processes.

In addition the middleware layer 43 and 53, enables the application to optimise the interactions between the various backend applications in a consistent manner. Providing a framework for adding new backend applications and updating the transaction workflows as business systems change over time.

An alternative embodiment could abstract the object transformation and transaction event logic into a form that could be stored in a data object that is read when the application starts or set of database tables that can be queried to retrieve the transformation cross references and execution logic for the middleware layer 43 or 53.

1-17. (canceled)

18. A method of integrating middleware and session functionality together to provide middleware layer functionality between a web application's user interface or web application service and business applications;
said method comprising:
sharing user's session data across multiple different applications by terminating the different applications into an integrating software component that allows the user to access and execute each application's components and store access data structures in the user's session common data area;
said method further comprising
a placing the middleware layer within and middleware data is stored as part of the user session environment; and
b effecting direct data access between the middleware layer and the user session storage; and
c effecting a standardised interface between the user interface or service and the business applications; and
d thereby to facilitate integration between multiple ones of the business applications.

19. The method of claim 1 further including the steps:
a the session middleware layer isolates the web application or mobile app service from the underlying business applications where:
b each user generated transaction triggers at least one primary transaction event in a business application;
c each user generated transaction can trigger one or more secondary transaction events in one or more business applications to complete the processing of the user transaction request;
d the session middleware layer functionality manages the business logic to determine the order in which business applications methods are executed to complete the user generated transaction requests.

20. The method of claim 1 wherein each transaction event process consists of:
a transforming of session middleware layer data objects into business application data objects
b calling the relevant business application method or function;
c transforming the data object returned by the business application method or function into a session middleware data object;
d returning the middleware object to session middleware layer.

21. The method of claim 1 wherein the session middleware layer is able to:
a transform any of the referenced business application data objects into a middleware layer equivalent and;
b transfer any middleware layer data object into a referenced business application data object.

22. The method of claim 1 wherein the session middleware layer contains the logic necessary to define the primary business application event and all secondary business application events needed to complete any arbitrary user transaction, thereby defining the process for completing any user generated request.
a and wherein the session middleware logic contains the necessary business rules to determine when any primary business application or secondary business application event is to be triggered, this logic includes: the source transaction event;
b system states to trigger the primary event;
c business application method to be called to complete the primary event;
d a list of secondary events where each secondary event is defined including:
i event sequence
ii the system status to trigger the secondary event,
iii business application method to be called to complete the secondary event ; and
iv the role back execution path for each transaction failure mode.

23. The method of claim 1 wherein the interfaces between the middleware layer and the business applications is reusable across multiple different middleware transaction events, or when new business applications are added to the middleware layer environment

24. The method of claim 1 wherein the cross references between middleware layer and business applications object can be implemented directly in middleware layer application source code or stored in a data file or database and loaded on application start up.

25. The method of claim 1 wherein the middleware event logic can be implemented directly in middleware layer application source code or stored in a data file or database and loaded on application start up.

26. A system consisting of a middle ware layer inserted between a web application's user interface or web application service that:
a is part of the user session environment;
b has direct access to the user session storage; and
c provides a standardised interface between the user interface or service and underlying business applications
d to facilitate the integration between the multiple business applications.

27. The system of claim 9 wherein a web application or mobile app service contains a session based middleware layer between the web application or mobile app service and the business applications, whereby the system facilitates the integration of user generated transactions generated via the web application with the one or more business applications; the system further including:
a means by which the session based middleware layer isolates the web application or mobile app service from the underlying business applications where:
b each user generated transaction triggers at least one primary transaction event in a business application;
c each user generated transaction can trigger one or more secondary transaction events in one or more business applications to complete the processing of the user transaction request;
d the session middleware layer functionality manages the business logic to determine the order of business applications methods are executed to complete the user generated transaction requests.

28. The system of claim 10 wherein each transaction event process consists of:
v transforming of session middleware layer data objects into business application data objects
vi calling the relevant business application method or function;
vii transforming the data object returned by the business application method or function into a session middleware data object;
viii returning the middleware object to the session middleware layer.

29. The system of claim 9 wherein the session middleware layer is able to:
a transform any of the referenced business application data objects into a middleware layer equivalent and;
b transfer any middleware layer data object into a referenced business application data object,

30. The system of claim 9 wherein the session middleware layer contains the logic necessary to define the primary business application event and all secondary business application events needed to complete any arbitrary user transaction, thereby defining the process for completing any user generated request.

31. The system of claim 9 wherein the session middleware logic contains the necessary business rules to determine when any primary business application or secondary business application event is to be triggered, this logic includes:
a the source transaction event;
b system states to trigger the primary event;
c business application method to be called to complete the primary event;
d a list of secondary events where each secondary event is defined including:
i event sequence
ii the system status to trigger the secondary event,
iii business application method to be called to complete the secondary event; and
iv the roll back execution path for each transaction failure mode.

32. The system of claim 9 wherein the interface between the middleware layer and the business applications is reusable across multiple different middleware transaction events, or when new business applications are added to the middleware layer environment.

33. The system of claim 9 wherein the cross references between middleware layer and business application objects can be implemented directly in middleware layer application source code or stored in a data file or database and loaded on application start up.

34. The system of claim 9 wherein the middleware event logic can be implemented directly in middleware layer application source code or stored in a data file or database and loaded on application start up.
